(19) United States
(12) Patent Application Publication
(10) Pub. No.: US 2006/0162213 A1
(43) Pub. Date: Jul. 27, 2006

(54) Changeable artwork display apparatus

(75) Inventor: Mary Ann Einarson, Chicago, IL (US)

Correspondence Address: BARNES & THORNBURG, LLP, P.O. BOX 2786, CHICAGO, IL, 60690-2786, US

(73) Assignee: Change of Art, Inc.

(21) Appl. No.: 11/297,955

(22) Filed: Dec. 8, 2005

Related U.S. Application Data
(60) Provisional application No. 60/634,738, filed on Dec. 9, 2004.

(51) Int. Cl. A47G 1/06; G09F 3/18

(52) U.S. Cl. 40/765; 40/722; 40/649

(57) ABSTRACT

An artwork display apparatus adapted to removably receive a piece of artwork including an artwork mounting member adapted to be coupled to a frame. The artwork mounting member includes a mat and a pocket coupled to the mat. The pocket and the mat form a receptacle adapted to removably receive the piece of artwork, such that the piece of artwork can be selectively inserted or removed from the receptacle through the opening without any disassembly.

### RELATED APPLICATIONS

This application claims the benefit of U.S. Provisional Application No. 60/634,738, filed Dec. 9, 2004.

### BACKGROUND

The present disclosure is directed to a changeable artwork display apparatus including an artwork mounting member adapted to be coupled to a frame, the artwork mounting member includes an open-ended receptacle adapted to removably receive a piece of artwork and is adapted to allow the artwork to be quickly and easily removed and replaced.

Prior picture frames included a frame member adapted to receive a piece of glass and a mat disposed adjacent to the glass. Prior to inserting the mat into the frame, a user attempted to somewhat blindly position or center a piece of artwork on the rear of the mat so that the artwork showed through the mat aperture in the desired position. The user then attempted to insert the mat and the artwork into the frame member without the artwork moving in relation to the mat. This process often required adhering the artwork to the mat by means of tape, glue or other adhesive. Typically, a rigid backer, such as a piece of hardboard, is then inserted into the frame member to keep the artwork from moving and to keep the artwork flush against the back of the mat. The rigid backer, artwork, mat and the glass are then retained within the frame member by inserting glazing points or positioning some other type of clasps into the frame member. In order to change the artwork, it was necessary to remove the glazing points or undo the clasps, remove the rigid backer, artwork and mat and then reassemble the new artwork and mat, clean the inside of the glass and ensure the glass is free of dust, lint and other debris prior to reinserting the mat and artwork, insert the mat and artwork without the artwork moving in relation to the mat, insert the rigid backer in the frame member and then re-insert or reposition the glazing points or other clasps to retain the rigid backer, artwork, mat and glass within the frame member. This is a time-consuming and often exasperating process.

Frequent and easy changing of artwork in a display apparatus is desirable. For example, families having young children may wish to display their most recent photographs of their children, and thus may be constantly changing the displayed photographs to the most recent photographs. In addition, with the advent of digital cameras and access of users to photograph processing software and equipment, lay people now have easy and low cost access to methods by which they can crop, adjust and print standard size photographs to achieve maximum appeal without the need to use time consuming and expensive third-party photograph processors. As a result, the average person now has low cost access to professional-looking photographic prints. Whereas it was previously desirable to permanently mount expensive and costly prints in picture frames, the low cost of obtaining high quality standard size prints has developed a market where persons wish to frequently and easily change their photographs and other artwork.

### SUMMARY

An artwork display apparatus adapted to removably receive a piece of artwork. The artwork display apparatus includes an artwork mounting member adapted to be coupled to a frame member. The frame member includes a peripheral rim adapted to receive the artwork mounting member. The artwork mounting member is coupled to the frame member. The artwork mounting member includes a mat and a pocket coupled to the mat. The mat has a front surface, a rear surface and a viewing window such as an aperture. The pocket overlies at least a portion of the viewing window. The pocket includes a connecting edge portion coupled to the mat. The pocket and the mat form a receptacle having an opening. The piece of artwork can be removably inserted into the receptacle through the opening such that the artwork is adapted to be viewed through the viewing window of the mat, and the artwork is adapted to be selectively removed from the receptacle through the opening, while the artwork mounting member remains coupled to the frame member.

### BRIEF DESCRIPTION OF THE DRAWING FIGURES

FIG. 1 is a front perspective view of the changeable artwork display apparatus.

FIG. 2 is a rear perspective view of the changeable artwork display apparatus.

FIG. 3 is a cross sectional view taken along line 3-3 of FIG. 2.

FIG. 4 is a front perspective view of the artwork mounting member.

FIG. 5 is a rear perspective view of the artwork mounting member.

FIG. 6 is a cross sectional view taken along line 6-6 of FIG. 5.

### DETAILED DESCRIPTION

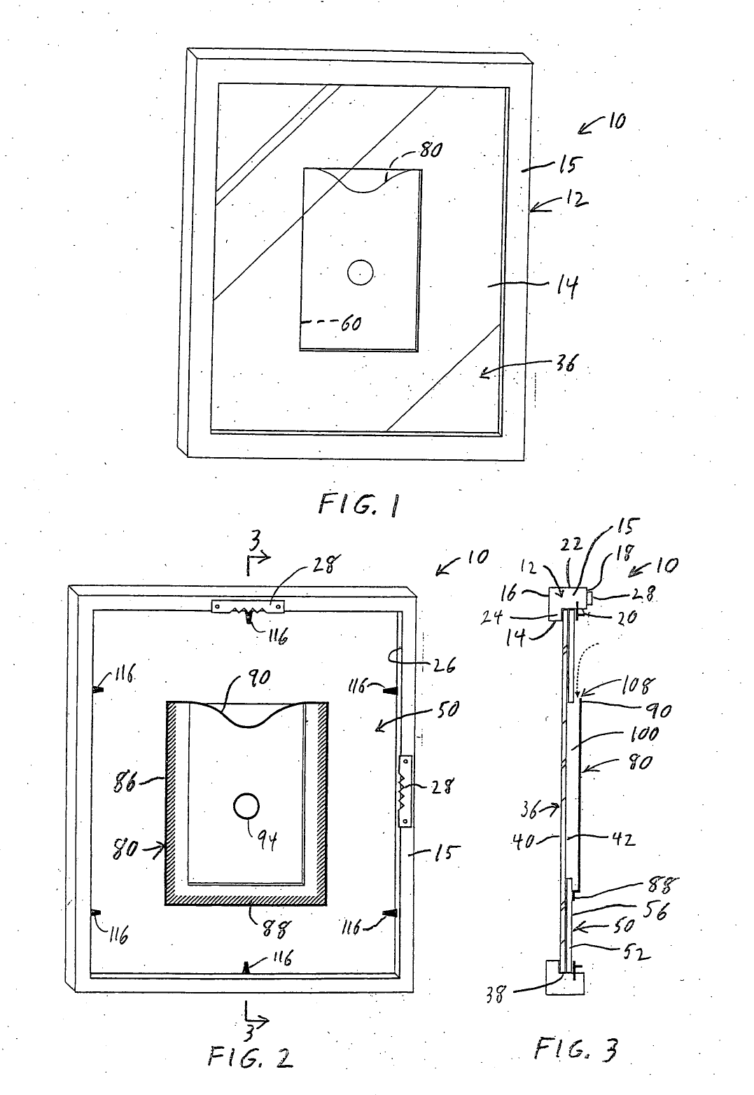

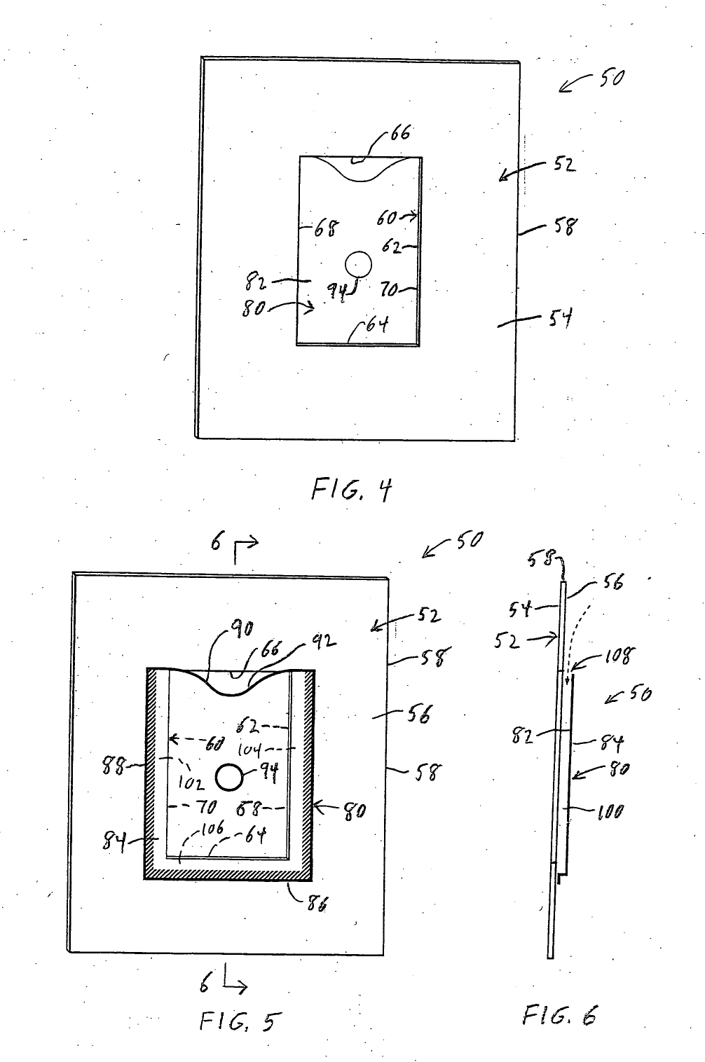

The changeable artwork display apparatus 10 is shown, as an example in FIGS. 1-3, as a picture frame. The display apparatus 10 includes a peripheral frame member 12 having a central viewing opening 14. The frame member 12 is shown as being generally rectangular in FIGS. 1 and 2, but may be formed in other geometric shapes, such as circular or oval shapes. Similarly, the viewing opening 14 as shown in FIGS. 1 and 2 is also generally rectangular, but may be formed in other geometric shapes, such as circular or oval shapes. The frame member 12 includes a peripheral rim 15 that extends between a front end 16 and a rear end 18. The rim 15 also extends between an inner end 20 and an outer end 22. The rim 15 farther includes a lip 24 at the front end 16 that extends inwardly from the inner end 20. The lip 24 forms a recess 26 along the inner end 20 of the rim 15. As shown in FIG. 2, a hanger member 28 is attached to the top end of the frame member 12 and a hanger member 28 is also attached to a side portion of the frame member 12. The hanger members 28 are adapted to removably mount the display apparatus 10 to a generally planar and vertical surface, such as the surface of a wall. The frame member 12 may be made of wood, plastic, metal and other materials as desired.

The artwork display apparatus 10 may include a glazing member 36 adapted to be removably coupled to the frame member 12. The glazing member 36 is a generally planar panel having a peripheral edge 38, a generally planar front surface 40, and a generally planar rear surface 42. The glazing member 36 is adapted to be located in the recess 26 of the frame member 12 such that the front surface 40 of the glazing member 36 is located adjacent the lip 24 of the frame member 12. The peripheral edge 38 of the glazing member 36 is sized and configured to extend closely adjacent to the inner end 20 of the frame member 12. The glazing member 36 is preferably transparent or translucent. The glazing member 36 may be formed from glass, acrylic or other plastic materials. The front surface 40 of the glazing member 36 is viewable through the viewing opening 14 of the frame member 12.

The artwork display apparatus 10 also includes an artwork mounting member 50. The artwork mounting member 50 includes a mat 52. The mat 52 is generally planar and is in the form of a thin panel. The mat 52 includes a generally planar front surface 54 and a generally planar rear surface 56 that is spaced apart from and generally parallel to the front surface 54. The mat 52 includes a peripheral edge 58 that extends around the perimeter of the mat 52. As shown in the drawing figures, the peripheral edge 58 is formed in a generally rectangular shape. However, the peripheral edge 58 can be formed in circular, oval and other geometric shapes as desired. The peripheral edge 58 is sized and configured to fit closely within the frame member 12 adjacent the inner end 20 of the frame member 12.

The mat 52 includes one or more viewing windows such as apertures 60 that extend through the mat 52 between the front and rear surfaces 54 and 56. The aperture 60 includes a peripheral edge 62, a bottom end 64, a top end 66, a left end 68 and a right end 70. As shown in drawing figures, the aperture 60 is generally rectangular, however, the aperture 60 may be formed in circular, oval or other geometric shapes as desired. A plurality of apertures 60 in the mat 52 may be arranged in various different configurations as desired with respect to one another. The mat 52 may be formed from various materials, including acid-free materials that will not react with photography or other printed art work. The mat 52 may be formed from card stock and other paper materials, or from plastic materials such as polystyrene or high-density polyvinyl chloride sheets sold under the registered trademark SINTRA. The mat material may be chosen based upon the intended use of the changeable artwork display apparatus, i.e. a polystyrene or high-density polyvinyl chloride mat may be used in high-humidity environments such as in kitchens or bathrooms where resistance to warping is desirable.

The artwork mounting member 50 also includes a pocket 80 that is coupled to the mat 52. The pocket 80 may be die-cut card stock or formed from a sheet of relatively thin material, and may be formed from a plastic material such as polyethylene. The pocket 80 includes a front surface 82 and a rear surface 84. The pocket 80 also includes a peripheral edge 86. The peripheral edge 86 includes a connecting edge portion 88 that is attached to the rear surface 56 of the mat 52. The peripheral edge 86 also includes a free edge portion 90 that is not directly attached to the rear surface 56 of the mat 52. The free edge portion 90 of the peripheral edge 86 forms an inwardly extending notch 92 in the pocket 80. The pocket 80 may also include a generally centrally located aperture 94 that extends between the front surface 82 and rear surface 84. The free edge portion 90 of the peripheral 86 is located at the top of the pocket 80 as shown in the drawing figures, but may be located at the left or right side of the pocket 80 if desired.

The pocket 80 overlies a substantial portion of the aperture 60 of the mat 52. The connecting edge portion 88 that is attached to the rear surface 56 of the mat 52 extends along the left end 66, the bottom end 64, and the right end 70 of the aperture 60 in the mat 52 in a generally U-shaped manner. The connecting edge portion 88 may be continuously or intermittently attached to the mat 52 along the length of the connecting edge 88. The connecting edge portion 88 extends along the left and right ends 68 and 70 of the aperture 60 from the top end 66 to the bottom end 64 of the aperture 60. The notch 92 of the pocket 80 is in communication with the aperture 60 at the top end 66 of the aperture 60. The aperture 94 of the pocket 80 is in communication with the aperture 60 of the mat 52. Depending upon the materials chosen, the connecting edge portion 88 of the pocket 80, for example, may be heat sealed to the rear surface of the mat 52, may be chemically bonded to the rear surface of the mat 52, may be bonded with adhesive to the rear surface of the mat 52, or may be integrally formed, such as by injection molding, with the mat 52.

The pocket 80 forms an open-end receptacle 100 with the mat 52 that is in communication with the aperture 60 of the mat 52. The connecting edge portion 88 of the pocket 80 is attached to the rear surface 56 of the mat 52 in a spaced apart relationship with the left end 88, bottom end 64 and right end 70 of the aperture 60 such that a left marginal portion 102, right marginal portion 104 and bottom marginal portion 106 of the mat 52, which are located respectively adjacent the left end 68, right end 70, and bottom end 64 of the aperture 60, form a portion of the receptacle 100 with the pocket 80. The receptacle 100 includes an opening such as an open end 108 between the free edge portion 90 of the pocket 80 and the mat 52 that provides access to the receptacle 100 from the exterior of the mounting member 50. As an example, the aperture 60 of the mat 52 may have dimensions of approximately 3½ inches by 5½ inches, with the receptacle area of the pocket measuring approximately 5.875 inches along marginal portions 102 and 104 by approximately 4.125 inches along marginal portion 106 for use with a standard 4 inch by 6 inch piece of artwork.

The mat 52 may have a size of 8 inches by 10 inches, or other dimensions, adapted to fit into a standard size frame member 12.

In operation, the artwork mounting member 50 is placed within the frame member 12 such that the peripheral edge 58 of the mat 52 is located closely adjacent the perimeter of the inner end 20 of the frame member 12, and such that the front surface 54 of the mat 52 is located adjacent the glazing member 36. Alternately, if a glazing member 36 is not used in connection with the frame member 12, the front surface 54 of the mat 52 is located adjacent the lip 24 of the frame member 12 and within the recess 26 of the frame member 12. The mounting member 50 is then coupled to the frame member 12 by one or more fasteners 116, such as glazing points. The artwork display apparatus 10 is then completely assembled.

A piece of artwork is removably inserted into the receptacle 100 of the artwork mounting member 50 by sliding the artwork through the open end 108 of the receptacle 100, such that the artwork is located between the rear surface 56 of the mat 52 and the front surface 82 of the pocket 80. The artwork may comprise, for example, photographs, prints, paintings, drawings, post cards, printed matter, and the like. The artwork overlies the aperture 60 of the mat 52 such that the artwork is viewable through the viewing opening 14 of the frame member 12, through the glazing member 36, and through the aperture 60 of the mat 52. The artwork is not located within the aperture 60 of the mat 52. The pocket 80 retains the artwork in a desired position within the receptacle 100 such that the artwork remains selectively positioned with respect to the aperture 60 of the mat 52.

The artwork is selectively removed from the receptacle 100 by manually engaging the top end of the artwork through the notch 92 in the free end portion 90 of the pocket 80, and if desired through the aperture 94 in the pocket 80. The artwork is slid upwardly through the open end 108 of the receptacle 100 until the artwork is completely removed from the receptacle 100. A different piece of artwork, or if desired the same artwork, may then be selectively inserted into the receptacle 100 of the mounting member 50 through the open end 108 for display in the artwork mounting member 50 and display apparatus 10 without the need to remove the mounting member 50 from the frame member 12, and without any type of disassembly of the display apparatus 10 or artwork mounting member 50. Once the mounting member 50 and frame member 12 are assembled, they never need to be disassembled in order to change the displayed artwork. Artwork may thereby be quickly and easily removed and replaced within the receptacle 100 of the artwork mounting member 50 such that the artwork displayed in the mounting member 50 and display apparatus 10 may be frequently changed with ease. The display apparatus 10 including the mounting member 50, with artwork located within the receptacle 100, may be mounted on a vertical surface for display of the artwork or on an easel for tabletop display of the artwork.

Various features of the invention have been particularly shown and described in connection with the illustrated embodiment of the invention, however, it must be understood that these particular arrangements merely illustrate, and that the invention is to be given its fullest interpretation within the terms of the appended claims.

What is claimed is:

1. An artwork mounting member adapted to removably receive a piece of artwork, said artwork mounting member comprising:
a mat having a front surface, a rear surface, and a viewing window; and
a pocket coupled to said mat, said pocket overlying at least a portion of said viewing window of said mat, said pocket including a connecting edge portion coupled to said mat, said pocket and said mat forming a receptacle, said receptacle having an opening;
whereby the piece of artwork can be removably inserted into said receptacle through said opening whereupon the artwork is adapted to be viewed through said viewing window of said mat.

2. The artwork mounting member of claim 1 wherein said viewing window of said mat comprises an aperture.

3. The artwork mounting member of claim 1 wherein said pocket includes a free edge portion, said opening of said receptacle being located between said free edge portion of said pocket and said mat.

4. The artwork mounting member of claim 3 wherein said free edge portion of said pocket includes a notch.

5. The artwork mounting member of claim 1 wherein said connecting edge portion of said pocket is generally U-shaped.

6. The artwork mounting member of claim 1 wherein said pocket includes an aperture in communication with said receptacle.

7. The artwork mounting member of claim 1 wherein said mat includes one or more marginal portions located between said viewing window and said connecting edge portion of said pocket.

8. The artwork mounting member of claim 1 wherein said pocket is coupled to said rear surface of said mat.

9. An artwork display apparatus adapted to removably receive a piece of artwork, said artwork display apparatus comprising:
a frame member;
an artwork mounting member coupled to said frame member, said artwork mounting member including a mat and a pocket coupled to said mat, said mat having a front surface, a rear surface and a viewing window, said pocket overlying at least a portion of said viewing window, said pocket including a connecting edge portion coupled to said mat, said pocket and said mat forming a receptacle, said receptacle having an opening;
whereby the piece of artwork can be removably inserted into said receptacle through said opening such that the artwork is adapted to be viewed through said viewing window of said mat, and such that said artwork is adapted to be selectively removed from said receptacle through said opening, while said artwork mounting member remains coupled to said frame member.

10. The artwork display apparatus of claim 9 including a glazing member located adjacent said front surface of said mat and being coupled to said frame, said pocket being coupled to said rear surface of said mat.

11. The artwork display apparatus of claim 9 wherein said viewing window of said mat comprises an aperture.

12. The artwork display apparatus of claim 9 wherein said pocket includes a free edge portion, said opening of said receptacle being located between said free edge portion of said pocket and said mat.

13. The artwork display apparatus of claim 12 wherein said free edge portion of said pocket includes a notch.

14. The artwork display apparatus of claim 9 wherein said connecting edge portion of said pocket is generally U-shaped.

15. The artwork display apparatus of claim 9 wherein said pocket includes an aperture in communication with said receptacle.

16. The artwork display apparatus of claim 9 wherein said mat includes one or more marginal portions located between said viewing window and said connecting edge portion of said pocket.

17. The artwork display apparatus of claim 9 wherein said pocket is coupled to said rear surface of said mat.

18. The artwork display apparatus of claim 9 wherein said frame member includes a peripheral rim.
